(19) United States
(12) Patent Application Publication
(10) Pub. No.: US 2011/0275714 A1
(43) Pub. Date: Nov. 10, 2011

(54) Use Of Cationic Surfactants As Acaricidal Agents

(75) Inventors: Xavier Rocabayera Bonvila, Palau-Solita (ES); Sergi Figueras Roca, Barcelona (ES)

(73) Assignee: LABORATORIOS MIRET, S. A., Les Fonts de Terrassa (ES)

(21) Appl. No.: 13/144,975

(22) PCT Filed: Jan. 12, 2010
(86) PCT No.: PCT/EP2010/050253

§ 371 Date: Jul. 18, 2011

(30) Foreign Application Priority Data
Jan. 22, 2009 (EP) 09382007.4

(51) Int. Cl. A01N 37/44; A01P 7/02

(52) U.S. Cl. 514/551

(57) ABSTRACT

This invention relates to a use of a composition for protecting against mites and ticks containing cationic surfactants such as ethyl-Nα-lauroyl-L-arginate HCl (LAE). It has been found that cationic surfactants such as ethyl-N^{α}-lauroyl-L-arginate HCl (LAE) and its salts are effective acaricidal agents.

### FIELD OF THE INVENTION

This invention relates to the use of cationic surfactants with antimicrobial properties as acaricidal agents.

### BACKGROUND ART

The order Acarina (class Arachnida) includes ticks and mites.

Ticks are parasitic during their life cycle. Ticks are annoying pests whose bites are irritating. When a tick is forcibly removed, its mouthparts frequently remain in the skin, resulting in a sore, an infection or even blood poisoning. Thus, from a public-health standpoint ticks are important as vectors of diseases of humans and other animals. Many species are quite resistant to environmental stress and may live for many years.

Mites inhabit most ecological settings, ranging from deserts to rain forests, mountain tops to tundra and saltwater ocean floors to freshwater lakes. The relative few species parasitic on humans produce dermatitis, often followed by allergic reactions. Mites that attack humans originate in a variety of habitats. Some, including the chicken mite and the tropical fowl mite, migrate to humans from birds. Others, such as grain mites and mushroom mites, are found in food materials or stored products.

Mold mites is a general term that refers to a variety of mites (e.g. members of the families acaridae, pyroglyphoidae and tarsonemidae) found in association with fungal growths such as mildew, moldy grain, and spoiled food. Many of these mites also are common in house dust.

Most mold mites feed directly on molds, and typically require microbial growth to develop, but others also eat the substrates supporting fungal growth. Common mold mites include the cheese mite (perhaps the most common being Tyrophagus putrescentiae, a member of the Acaridae), the flour mite Dermatophagoides farinae (a pyroglyphid mite related to a common house dust mite of temperate regions, D. dermatophagoides), and the grain mite (Acaridae).

More specifically, the mite Tyrophagus putrescentiae is one of the main mites that causes important problems in the food industry, in particular the cured ham industry. This type of mite is frequently found in a big variety of stored products, specially those products with a high content in proteins and fats, such as hams and cheeses. The mites can easily spread in the industry of hams since hams are processed under favourable conditions for them.

Mold mites are very common, but usually go unnoticed except when they become abundant. They can infest stored food and grain and cause tremendous losses, although they are more commonly an annoyance and nuisance and not injurious. However, as with house dust mites, the exuviae and feces of dust mites may contribute to the development of atopic asthma, rhinitis, and other allergic reactions such as dermatitis in sensitive individuals. Mold mite populations develop to significant levels only where there are microclimates with sufficient humidity and a substrate that will support fungal growth, e.g. areas with leaky pipes and porous surfaces (e.g. wood, rugs, furniture), poorly sealed windows, attics with leaky roofs, hygroscopic foods, and containers of grains, flour, potatoes, etc. The longer infested foods are kept, the higher the mite populations.

A family of exceptionally small mites, usually 0.5 millimeter or less in length, is abundant in dried fruits and meats, grain, meal, and flour, and frequently causes severe dermatitis in persons hypersensitized by frequent handling of infested products.

Usually, mites have been treated with chemical products (acaricides). However the growing use of chemical compounds to fight mites has implied the increase of toxicity and the presence of residual substances in the treated foodstuff. For example, phosphine (PH₃) has been traditionally used to control the presence of mites in foodstuff. It is effective but it requires high doses to be applied and long time of exposure. Other substances are methyl bromide, CO₂, ozone and essential oils.

Antibiotic miticides, carbamate miticides, formamidine miticides, mite growth regulators, organochlorine, permethrin and organophosphate miticides are all in the category of mite-killing pesticides. Diatomaceous earth will also kill mites by disrupting the cuticle, which dries out the mite. Ivermectim can be prescribed by medical doctors to rid humans of mite and lice infestations and there are agricultural formulations for birds and rodents that are infested.

A common miticide is methoprene. Methoprene is virtually harmless to non-insects, and the US Environmental Protection Agency has exempted it from tolerance. It is widely available in supermarkets, etc. Hydroprene is toxic to fish and perhaps birds. Both agents are for indoor use only, as they break down in sunlight. Methoprene is applied as a wetting spray, hydroprene as an aerosol space spray. Neither will affect adult insects; they work on future generations by preventing growth or maturation. Permethrin can be applied as a spray.

In general, most part of methods employed to eliminate mites in food products show a lot of disadvantages because they change the organoleptic properties of the food product. Also they are aggressive to the environment and to the consumers due to the presence of remaining chemical substances in the final product.

There is a permanent want of effective miticides which are well tolerated and non-toxic to human beings and any domestic animals which get into contact with the agents.

The WO 2005/009122 patent application covers the use of a microwave method of controlling mites in a food product of animal origin. This is an alternative method that does not imply the use of chemical products to control the presence of mites in food products. For example, the inventors treat a cured ham with microwaves.

The WO 95/13703 covers the use of benzoylureas for controlling house dust mites. Some benzoylurea compounds have high insecticidal and acaricidal activities against certain insects and mites but are ineffective against house dust mites. The document describes that a group of certain benzoylureas has an outstanding activity against dust mites.

In U.S. Pat. No. 5,607,711, a method of causing irreparable or lethal damage to insects and mites is described, by exposing them with electromagnetic energy in the ultraviolet spectrum wherein the undesired organisms are selectively heated and destroyed without causing damage to the food.

The methods covered in the above documents from the prior art are focussed on reducing or exterminating the presence of insects and mites.

Therefore, there is a need for finding new methods with a preventing character to the growth of acaricidal agents which do not create a residue in the treated product and also are effectively destroying mites and ticks when they are present in food supplies, agriculture, indoor atmospheres, cosmetics or other applications.

Cationic surfactants are known as preservatives used in food, cosmetic and pharmaceutical industry. Cationic surfactants have turned out to be highly effective against microbial proliferation and at the same time safe for intake in humans and mammals in general. For all of this, cationic surfactants are an attractive tool in the industry.

It has been demonstrated that cationic surfactants according to formula (1) derived from the condensation of fatty acids and esterified dibasic amino acids are highly effective protective substances against microorganisms.

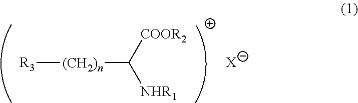

where:
X⁻ is a counter ion derived from an organic or inorganic acid, preferably Br⁻, Cl⁻ or HSO₄⁻, or an anion on the basis of a phenolic compound;
R₁: is a straight alkyl chain from a saturated fatty acid or hydroxyl acid having from 8 to 14 atoms linked to the α-amino acid group via an amidic bond;
R₂: is a straight or branched alkyl chain from 1 to 18 carbon atoms or an aromatic group;

### R₃: is

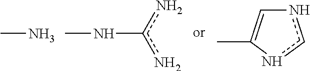

where n is from 0 to 4.

The organic acids which may be the source of the counter ion X⁻ can be citric acid, lactic acid, acetic acid, fumaric acid, maleic acid, gluconic acid, propionic acid, sorbic acid, benzoic acid, carbonic acid, glutamic acid or other amino acids, lauric acid and fatty acids such as oleic acid and linoleic acid, whereas the inorganic acids can be phosphoric acid, nitric acid and thiocyanic acid.

The phenolic compound which may be the basis of the anion X− is for instance butylated hydroxyanisole (BHA) and the related butylated hydroxytoluene, tertiary butyl hydroquinone and parabens such as methylparaben, ethylparaben, propylparaben and butylparaben.

The most preferred compound of the above class of compounds is the ethyl ester of the lauramide of the arginine monohydrochloride, hereafter referred to as LAE (CAS No. 60372-77-2). This compound is now well-known for its use as an antimicrobial agent. In practical use LAE turned out to be well tolerated and to display a very low toxicity to human beings. LAE has the chemical structure of formula (2) displayed hereafter.

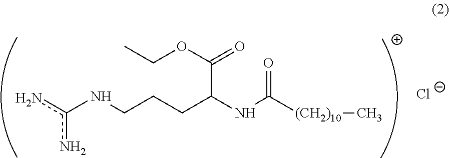

The compound LAE is remarkable for its activity against different microorganisms, like bacteria, moulds and yeasts which can be present in food products (WO 03/034842) and also in cosmetic formulations and preparations (WO 03/013453, WO 03/013454 and WO 03/043593). The compound has been furthermore described for its effect on parasites in fish, such as on the larvae of Anisakis or other species (European application EP 07 382 004.5). Its preservative action is particularly pronounced in a combination with a polyene fungicide such as natamycin (PCT/EP2007/060598). It has furthermore been shown to be effective for killing endospores and for having an effect in virus infections (European application EP 08382025.8). The specific use for the protection of teeth against dental erosion has been described (European application EP 08 382 007.6).

The general preparation of the cationic surfactants is described in Spanish patent ES 512643 and international patent applications WO 96/21642, WO 01/94292 and WO 03/064669.

LAE, also known as lauric arginate, is manufactured by Laboratorios Miret, S.A. (LAMIRSA, Spain). Lauric arginate is listed by the FDA (Food and Drug Administration) as being a GRAS substance (Generally Recognized As Safe) under GRN 000164. The USDA (United States Department of Agriculture) has approved its use in meat and poultry products (FSIS Directive 7120.1) and also as a processing aid for fresh meat and poultry products.

The metabolism of the above cationic surfactant of formula (2) in rats has been studied; these studies have shown a fast absorption and metabolisation into naturally-occurring amino acids and the fatty acid lauric acid, which are eventually excreted as carbon dioxide and urea. Toxicological studies have demonstrated that LAE is completely harmless to animals and humans.

Therefore, LAE and related compounds are particularly suitable to be used in the preservation of all perishable food products. LAE and related compounds are equally suitable for use in cosmetic products.

As has been remarked above, the cationic surfactants are remarkable for their inhibitory action over the proliferation of different microorganisms, such as bacteria, fungi and yeasts. The minimum inhibitory concentrations of LAE are shown in the following table 1.

TABLE 1

| Kind | Microorganism | M.I.C. (ppm) |
|---|---|---|
| Gram + | Arthrobacter oxydans ATCC 8010 | 64 |
| Bacteria | Bacillus cereus var mycoide ATCC 11778 | 32 |
| | Bacillus subtilis ATCC 6633 | 16 |
| | Clostridium perfringens ATCC 77454 | 16 |
| | Listeria monocytogenes ATCC 7644 | 10 |
| | Staphylococcus aureus ATCC 6538 | 32 |
| | Micrococcus luteus ATCC 9631 | 128 |
| | Lactobacillus delbrueckii ssp lactis CECT 372 | 16 |
| | Leuconostoc mesenteroides CETC 912 | 32 |
| Gram − | Alcaligenes faecalis ATCC 8750 | 64 |
| Bacteria | Bordetella bronchiseptica ATCC 4617 | 128 |
| | Citrobacter freundii ATCC 22636 | 64 |
| | Enterobacter aerogenes CECT 689 | 32 |
| | Escherichia coli ATCC 8739 | 32 |
| | Escherichia coli 0157H7 | 20 |
| | Klebsiella pneumoniae var pneumoniae CECT | 32 |
| | 178 | |
| | Proteus mirabilis CECT 170 | 32 |
| | Pseudomonas aeruginosa ATCC 9027 | 64 |
| | Salmonella typhimurium ATCC16028 | 32 |
| | Serratia marcenses CECT 274 | 32 |
| | Mycobacterium phlei ATCC 41423 | 2 |
| Fungi | Aspergillus niger ATCC14604 | 32 |
| | Aureobasidium pullulans ATCC 9348 | 16 |
| | Gliocadium virens ATCC 4645 | 32 |
| | Chaetonium globosum ATCC 6205 | 16 |
| | Penicillium chrysogenum CECT 2802 | 128 |
| | Penicillium funiculosum CECT 2914 | 16 |
| Yeast | Candida albicans ATCC 10231 | 16 |
| | Rhodotorula rubra CECT 1158 | 16 |
| | Saccharomyces cerevisiae ATCC 9763 | 32 |

It is preferred to dissolve the compound directly before use in one of the following preferred solvents of food grade: water, ethanol, propylene glycol, isopropyl alcohol, other glycols, mixtures of glycols and mixtures of glycols and water, diacetin, triacetin, glycerol, sorbitol, mannitol and xylitol. If the treatment shall be performed at a specific pH value the use of a corresponding buffer solution may be recommendable. On the other hand the compound can be easily used in its solid form or formulated with solid carriers such as salt, sugar, maltodextrine, hydrocolloids and sorbitol.

For the cationic surfactants of the above formula (1) the antibacterial activity and the biological activity against other microorganisms such as fungi and yeasts is well documented.

### SUMMARY OF THE INVENTION

It is the object of the present invention to provide a further effective method for the treatment of the presence of ticks and mites.

More in particular, it is the object of the present invention to provide a novel method for preventing and inhibiting the presence of mites in food and cosmetic products and medical applications without providing a chemical residue, being environmental friendly and without altering the organoleptic properties of the treated product.

The present invention provides a method of preventing the presence of mites and ticks in agriculture, in animals and human bodies and also into indoor atmospheres where the invention surprisingly avoid the risk of allergies.

The inventors have surprisingly observed that the objects of the present invention can be solved using the cationic surfactants derived from the condensation of fatty acids and esterified dibasic amino acids of the above formula (1). It has been observed that the treatment with these cationic surfactants reduces the mean number of individuals present in food after infestation or prevents the infestation of food when these cationic surfactants are applied as a preventing method.

### DESCRIPTION OF THE PREFERRED EMBODIMENTS

The most preferred compound of the above class of compounds of formula (1) is the ethyl ester of the lauramide of the arginine monohydrochloride, hereafter referred to as LAE (CAS No. 60372-77-2). This compound is particularly effective as a miticidal agent. LAE has the chemical structure of formula (2) displayed hereafter.

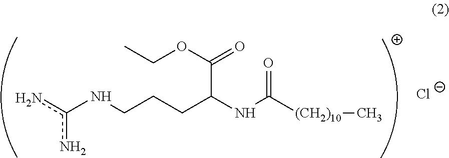

The cationic surfactants of the general formula (1) have been described as antimicrobial agents. Since mold mites are regularly present in association with mold growth, the current antimicrobial effect against molds will have the first effect on the development of mite and tick populations. It may help to avoid the generation of the kind of environment which is required for the survival of the Acari. The second effect is the direct acaricidal effect which is displayed by the cationic surfactants of the above formula (1).

The acaricidal effect will be present in all kinds of products in which any of the cationic surfactants of general formula (1) is present. The cationic surfactants are regularly used as preservative agents in such products as food products and medical and cosmetic preparations or for medical devices.

It is particularly preferred to use the cationic surfactants for the preservation of meat products, like for instance meat, poultry products, fish, crustaceans, vegetables, greens, emulsions, sauces, confectionery, bakery, dairy products, egg-based products, jams, jellies, beverages, juices, wines, beers, etc. In all such preserved food products the problems with mold mites or similar pests will not be met.

The cosmetic compositions which are preserved with any of the cationic surfactants of the general formula (1) can have the aspect of a cream, a lotion, a milk, an emulsion, a gel or an oil for the skin, a beauty mask, a salt, a gel, a foam/spray or an oil for a bath and shower, or for make-up and make-up cleaner of the face and eyes and any further aspect to be shown.

The cosmetic compositions which are treated according to the present invention comprise a medium which is compatible with the skin, the mucous membranes, and hair. These compositions may contain the usual components such as: fatty compounds such as mineral oil, animal oil, vegetable oil, from synthesis and silicon, and also alcohols, fatty acids and waxes; organic solvents, surface active agents, solubilizers and ionic and non ionic emulsifiers, thickening agents and jellying hydrophilic agents such as carboxyvinylic polymers (e.g. carbomer), acrylic copolymers (e.g. acrylates and alkylacrylates), polyacrylamides, polysaccharides, natural gums (e.g. xanthan gum); thickening agents and jellying lipophilic agents such as modified clays (ex. bentonite), fatty acid metallic salts, hydrophobic silica and polyethylene; perfumes and essential oils; softeners; excipients; antioxidants; sequestrant agents; opacifiers; filters; colouring compounds which are either hydrophilic or lipophilic, and pigments; and hydrophilic or lipophilic active ingredients.

The amounts of these usual components mentioned in the previous paragraph are the normal ones as used in the art.

In all of these food products and cosmetic preparations the presence of the cationic surfactant will prohibit the problem of the direct infestation with mites or similar pests. For the products which contain a cationic surfactant for antimicrobial preservation, the acaricidal effect may be considered to be an additional effect which is highly beneficial.

In the context of the present invention, it may be recommendable to treat any kind of critical product with the cationic surfactant. Products may be considered critical for their mere nature which makes them susceptible to be infested with mites and ticks, or for the circumstances of high temperature and humidity which increases the chance of infestation with mites and similar pests. In such cases the cationic surfactants of formula (1) are added specifically to achieve the acaricidal effect which is wanted.

When the cationic surfactants of general formula (1) are added to food products and medical and cosmetic preparations, the concentration which is required to choice the effect against the acarina is in the same range as is regularly used to achieve the preservative action.

The required concentration in the food products is in the range of 0.0001% to 5% by weight preferably 0.001% to 0.5% by weight, more preferably 0.005% to 0.3% by weight, even more preferably 0.01% to 0.1% by weight, all indications relative to the total weight of the food product.

The required concentration of the cationic surfactants in the cosmetic compositions is in the range of 0.001% to 1% by weight, preferably 0.01% to 0.5% by weight, more preferably 0.05% to 0.1% by weight, all indications relative to the total weight of the cosmetic composition.

The required concentration of cationic surfactants in other applications like agriculture, medical devices, animals and human bodies is in the range of 0.0001% to 5% by weight and preferably 0.001% to 2%.

It is also possible to treat not the products which may be affected by the mites and ticks, but rather the environment where such products which may be affected are stored. This kind of treatment may comprise the treatment of surfaces such as floors in storage rooms, the walls of storage rooms, cupboards and shelves. These surfaces may be treatment by washing with solutions comprising the cationic surfactant of general formula (1), by spaying such solutions, by treatment with the product in powder form, or any other suitable manner.

If the surfaces are treated with a preparation of the cationic surfactant of formula (1), the amount which is applied shall be such that the amount of the cationic surfactant of formula (1) is in the range of 0.01 mg/dm² to 10,000 mg/dm², preferably an amount of 0.5 mg/dm² to 5,000 mg/dm², and more preferably an amount of 1 mg/dm² to 100 mg/dm².

If the surfaces which are treated with a preparation of the cationic surfactant of formula (1) are related to the storage of food products and the cationic surfactants are applied as a solution, in that case the liquid basis of the solution may be any liquid which is suitable for use in the preparation of food. Such liquids are water, propylene glycol, ethanol, or glycerine. Mixtures of these liquids are possible as well.

Water may refer to tap water, demineralised water, distilled water, or solutions of any suitable salt in water.

Solutions in aqueous solutions are preferred. As the vehicle for the solution, water, such as tap water or demineralised water, is the most suitable, solutions in brine are also possible.

Addition of further solvents are possible, such as any organic solvent, as long as this further added solvent does not cause any negative effect on later consumption by human consumers. In general, there is no specific advantage in adding further solvents and the administration of a solution in tap water is sufficient for usual purposes.

For the wanted effect on the mites and ticks a sufficient concentration of the cationic surfactant needs to be achieved on the surfaces. It has been observed that such sufficient concentration is achieved when the solution contains the cationic surfactant in a concentration of 0.001% to 50% by weight. A more preferred concentration is in the range of 0.1% to 5% by weight.

The treatment may be conducted once or several times, dependent on the course of the contamination.

### DETAILED DESCRIPTION OF PARTICULAR EMBODIMENTS

The following examples pretend to illustrate the field of application of this invention and the values given may be extended or changed without losing the effects which are sought, as will be apparent to the skilled person with an understanding of the teaching herein.

### Example 1

This example determines the activity of LAE against a type of tick, Hyalomma marginatum rufipes.

### Methodology:

During 3 weeks adult ticks of Hyalomma marginatum rufipes were unfed. 15 unsexed ticks were introduced in each vial of treatment. All vials were closed with a mesh and plastic bands in order to avoid that ticks could escape from the vials. The mortality of ticks was studied 24 h later and compared from the different treatments performed.

Two types of treatment were performed and then compared with the control. One treatment consisted in a dispersion of 0.2% LAE in a food carrier. The other treatment was 1.0% LAE in a food carrier. The control was a vial that contained the ticks without LAE. For each treatment and control samples 5 replicates were carried out.

### Results:

After 24 hours of contact of ticks with LAE in the vials, the percentage of mortality of ticks was determined (Table 2).

TABLE 2
Effect of the addition of LAE on the survivorship
of ticks (n = 5; mean ± SEM):

| Treatment | Mortality |
|---|---|
| Control | 0% |
| 0.2% LAE | 6.7% |
| 1.0% LAE | 38.7% |

### Conclusions:

There is a clear effect of LAE on the tick population. At 1.0% of LAE, this substance is surprisingly able to reduce the number of ticks in almost 40% after 24 h of having initiated the treatment. At a dose level of 0.2% LAE is detectable the activity of LAE against ticks proving that LAE is surprisingly active against ticks.

### Example 2

This example determines the effect of LAE on the mortality, reproduction and immature development of Mold mite Tyrophagus putrescentiae.

### Methodology:

Mixed developmental stages of the Mold mite, Tyrophagus putrescentiae, were used in the experiments. The individuals of the species came from IRTA, Crop Protection Department and had been maintained on standard diets at 25±1° C., 70±10% r.h. and a photoperiod of 16:8 L:D. Experiments were conducted in a climatic chamber at the same environmental conditions.

The food additive (LAE) was supplied by the company VEDEQSA as a fine sifted dust, and was uniformly mixed with a mix of bran, brewer's yeast and glycerin for the Mold mite. A high dosage of 1% LAE was tested. A control treatment with no food additive was included for reference. Fifteen replications per treatment were prepared.

For the mold mite, the experimental arenas were ventilated plastic cages (100 ml) containing 15 g of a mixed diet (bran, brewer's yeast and giycerine). Mites were added to arenas in numbers of 25 individuals. Plastic cages were isolated in hermetic boxes containing a solution of glycerine in order to maintain the relative humidity at 75%.

Six weeks after T. putrescentiae infestation the total number of individuals present in each replication was counted.

The mean number of individuals and individual weights were compared between treatments with or without the additive for the pest species using a one-way analysis of variance (ANOVA) procedure and means were separated by Tukey test (PROC GLM; SAS Institute 2000).

### Results:

The Mold mite, T. putrescentiae, did not survive in the standard rearing diet with the addition of 1% LAE. Significant differences were found in the number of individuals recovered from the 1% LAE and control treatments six weeks after infestation (Table 3).

TABLE 3
Effect of the addition of LAE on the survivorship of Mold mites found
at the end of the experiment (n = 15; mean ± SEM)

| LAE | Mold mites |
|---|---|
| treatment | number |
| Untreated | 48 ± 20.6 |
| 1% | 0.1 ± 0.1 |

The mean values are significantly different (P>0.05)

### Conclusions:

The survivorship of the Mold mite in the standard diet containing an additional 1% of LAE is very low. This result surprisingly shows the benefit of using LAE as an additive for the control of this species of mites.

### Example 3

This example determines the effect of three different concentrations of LAE on the mortality, reproduction and immature development of mold mite Tyrophagus putrescentiae. The dose level tested were 0.125%, 0.25% and 0.5% of LAE.

### Methodology:

Mixed developmental stages of the Mold mite, Tyrophagus putrescentiae, were used in the experiments. The individuals of this specie came from IRTA, Crop Protection Department and had been maintained on standard diets at 25±1° C., 70±10% r.h. and a photoperiod of 16:8 L:D. Experiments were conducted in a climatic chamber at the same environmental conditions.

The food additive Mirenat-G (10.5% LAE in glycerin) was supplied by the company VEDEQSA and was uniformly mixed with a mix of bran, brewer's yeast for the Mold mite. It was tested at the following dosages of 0.125%, 0.25% and 0.5% LAE. A control treatment with no food additive was included for reference. Fifteen replications per treatment were prepared.

For the mold mite, the experimental arenas were ventilated plastic cages (100 ml) containing 15 g of a mixed diet (bran, brewer's yeast and glycerin). Mites were added to arenas in numbers of 25 individuals. Plastic cages were isolated in hermetic boxes containing a solution of glycerine in order to maintain the relative humidity at 75%.

Four weeks after T. putrescentiae infestation the total number of individuals present in each replication was counted.

The mean number of individuals were compared between treatments with or without the additive for the pest specie using a one-way analysis of variance (ANOVA) procedure and means were separated by Tukey test (PROC GLM; SAS Institute 2000).

### Results:

For the Mold mite, T. putrescentiae, a reduction in the mean number of individuals present after 4-week infestation was recorded as the dosage of LAE increased (up to 70% at 0.5% of LAE) (Table 4).

TABLE 4
Effect of the addition of LAE on the survivorship of Mold mites at
the end of the experiment (n = 15; means ± SEM):

| LAE | Mold mites |
|---|---|
| treatment | number |
| Untreated | 22.7 ± 8.68 |
| 0.125% | 20.9 ± 9.77 |
| 0.25% | 13.17 ± 3.70 |
| 0.5% | 6.7 ± 1.49 |

The addition of an increase dosage (0.125%, 0.25% and 0.5%) of LAE to the standard diet of the Mold mite caused a reduction in the mean number of individuals present after 4 weeks of infestation.

### Example 4

A dose level of 200 ppm of LAE (or 0.02% of LAE) was added onto the surface of a ham at the beginning of its curing process. The results were compared with a control sample that consisted on a cured ham without being treated with LAE. All hams (control and treated with LAE) were cured during a period of 6 months.

After 6 months, when the curing process was finished it was observed that 85% of ham not treated with LAE (control samples) had mite colonies alive onto the surfaces of hams. In contrast, only 30% of hams treated with LAE had mite colonies alive onto their surface.

Before delivering the hams to the client, the producer extracted the bone in order to slice the ham. It was observed that 25% of ham non-treated with LAE (control) contained mite colonies alive inside the ham. The presence of mite colonies produced the formation of holes between 2 to 3 cm of diameter. These holes in the ham looked like a putrefacted ham.

For the sliced ham treated with LAE, there was no presence of mite colonies alive inside the ham.

All examples show how LAE was surprisingly effective not only in exterminating the presence of mites and ticks but also in preventing their infestation. Moreover, this invention comprises a non-residue method of destroying mite colonies in food products. Thus, the use of cationic surfactants and more specifically the use of LAE can replace the use of chemical pesticides that usually create residues being detrimental to the environment and could affect the consumer health.

1-8. (canceled)

9. A method of preventing or inhibiting the presence of at least one of Acarina, mites and ticks in or on at least one of foods, cosmetic products, medical applications, indoor atmosphere, agricultural products, animals and humans, the method comprising applying to the at least one of foods, cosmetic products, medical applications, surfaces, indoor atmosphere, agricultural products, animals and humans, a cationic surfactant, useful as an acaricidal agent and derived from the condensation of fatty acids and esterified dibasic amino acids, according to the following formula (1): 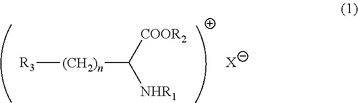
wherein, n is from 0 to 4,
X⁻ is a counter ion derived from an organic or inorganic acid;
R₁: is a straight alkyl chain from a saturated fatty acid or hydroxyl acid having from 8 to 14 atoms linked to the α-amino acid group via an amidic bond;
R₂: is a straight or branched alkyl chain having from 1 to 18 carbon atoms or an aromatic group;
R₃: is selected from the group consisting of

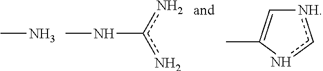

10. The method of claim 9, wherein X⁻ is derived from an acid selected from the group consisting of citric acid, lactic acid, acetic acid, fumaric acid, maleic acid, gluconic acid, propionic acid, sorbic acid, benzoic acid, carbonic acid, glutamic acid, amino acids, lauric acid, fatty acids, oleic acid, linoleic acid, phosphoric acid, nitric acid and thiocyanic acid.

11. The method of claim 9, wherein X⁻ is selected from the group consisting of Br⁻, Cl⁻ and HSO₄⁻.

12. The method of claim 9, wherein X⁻ is an anion on the basis of a phenolic compound selected from the group consisting of butylated hydroxyanisole, butylated hydroxytoluene, tertiary butyl hydroquinone, parabens, methylparaben, ethylparaben, propylparaben and butylparaben.

13. The method of claim 9, wherein the cationic surfactant is present in a food product at a concentration from 0.0001% to 5% by weight.

14. The method of claim 9, wherein the cationic surfactant is present in a food product at a concentration from 0.001% to 0.5% by weight.

15. The method of claim 9, wherein the cationic surfactant is present in a cosmetic composition at a concentration from 0.001% to 1% by weight.

16. The method of claim 9, wherein the cationic surfactant is present in a cosmetic composition at a concentration from 0.01% to 0.5% by weight.

17. The method of claim 9, wherein the cationic surfactant is present in at least one of a house, agricultural product, an animal and a human at a concentration from 0.0001% to 5% by weight.

18. The method of claim 9, wherein the cationic surfactant is present in at least one of a house, agricultural product, an animal and a human at a concentration from 0.001% to 2%. by weight.

19. The method of claim 9, wherein the cationic surfactant is present on surfaces at a concentration from 0.01 mg/dm² to 10,000 mg/dm².

20. The method of claim 9, wherein the cationic surfactant is present on surfaces at a concentration from 0.5 mg/dm² to 5,000 mg/dm².

21. The method of claim 9, wherein the cationic surfactant is present in solid form, spray form, or solution form.

22. The method of claim 9, wherein the cationic surfactant is present in a solution or mixture that also includes at least one selected from the group consisting of water, ethanol, glycols, propylene glycol, isopropyl alcohol, diacetin, triacetin, glycerol, sorbitol, mannitol, xylitol, buffer solutions, salts, sugars, maltodextrins, hydrocolloids and combinations thereof.

23. The method of claim 9, wherein the cationic surfactant is present in a solution or mixture that also includes at least one selected from the group consisting of water, propylene glycol and glycerol.

24. The method of claim 9, wherein the cationic surfactant is the ethyl ester of the lauramide of arginine hydrochloride (LAE).

25. The method of claim 24, wherein LAE is present in solid form, spray form, or solution form.

26. The method of claim 24, wherein the LAE is present in a solution or mixture that also includes at least one selected from the group consisting of water, ethanol, glycols, propylene glycol, isopropyl alcohol, diacetin, triacetin, glycerol, sorbitol, mannitol, xylitol, buffer solutions, salts, sugars, maltodextrine, hydrocolloids and combinations thereof.

27. The method of claim 24, wherein the LAE is present in a solution or mixture that also includes at least one selected from the group consisting of water, propylene glycol and glycerol.
